(19) United States
(12) Patent Application Publication
(10) Pub. No.: US 2025/0351173 A1
(43) Pub. Date: Nov. 13, 2025

(54) A METHOD OF RESOURCE SELECTION ON UNLICENSED BAND

(71) Applicant: Lenovo (Beijing) Limited, Beijing (CN)

(72) Inventors: Xiaodong Yu, Beijing (CN); Haipeng Lei, Beijing (CN); Zhennian Sun, Beijing (CN); Yu Zhang, Beijing (CN); Xin Guo, Beijing (CN)

(73) Assignee: Lenovo (Beijing) Limited, Beijing (CN)

(21) Appl. No.: 18/858,808

(22) PCT Filed: Apr. 28, 2022
(86) PCT No.: PCT/CN2022/089763

§ 371 Date: Oct. 22, 2024

(51) Int. Cl. H04W 74/0816; H04W 28/26; H04W 72/25; H04W 74/08

(52) U.S. Cl. CPC H04W 74/0816; H04W 28/26; H04W 72/25; H04W 74/0875

(57) ABSTRACT

Methods and apparatuses for resource selection on unlicensed band are disclosed. A method may comprises receiving, a Sidelink Control Information (SCI) indicating that a resource at a time slot is reserved for a subsequent transmission, wherein, the SCI at least comprises a Listen Before Talk (LBT) type indication that indicates a LBT operation type for the subsequent transmission on a reserved resource; and determining, based at least in part on the SCI for the subsequent transmission and/or a LBT operation type of the first UE, one or more resources to be excluded from a candidate resource set.

### FIELD

The subject matter disclosed herein generally relates to wireless communications, and more particularly relates to a method of resource selection on unlicensed band.

### BACKGROUND

The following abbreviations are herewith defined, at least some of which are referred to within the following description: Third Generation Partnership Project (3GPP), European Telecommunications Standards Institute (ETSI), Frequency Division Duplex (FDD), Frequency Division Multiple Access (FDMA), Long Term Evolution (LTE), New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), Personal Digital Assistant (PDA), User Equipment (UE), Uplink (UL), Evolved Node B (eNB), Next Generation Node B (gNB), New Radio (NR), Downlink (DL), Central Processing Unit (CPU), Graphics Processing Unit (GPU), Field Programmable Gate Array (FPGA), Dynamic RAM (DRAM), Synchronous Dynamic RAM (SDRAM), Static RAM (SRAM), Liquid Crystal Display (LCD), Light Emitting Diode (LED), Organic LED (OLED), Next Generation Node B (gNB), Orthogonal Frequency Division Multiplexing (OFDM), Radio Resource Control (RRC), Reference Signal (RS), Time-Division Duplex (TDD), Time Division Multiplex (TDM), User Entity/Equipment (Mobile Terminal) (UE), Uplink (UL), Universal Mobile Telecommunications System (UMTS), Long Term Evolution (LTE), Narrowband (NB), Physical Downlink Shared Channel (PDSCH), Physical Uplink Shared Channel (PUSCH), Physical Uplink Control Channel (PUCCH), Downlink control information (DCI), Universal Mobile Telecommunications System (UMTS), Evolved-UMTS Terrestrial Radio Access (E-UTRA or EUTRA), Media Access Control (MAC), Control Element (CE), Bandwidth Part (BWP), Technical specification (TS), sidelink (SL), Discontinuous Reception (DRX), in the coverage of network (IC), out of coverage of network (OOC), Sidelink Control Information (SCI), Physical Sidelink Control Channel (PSCCH), Radio Network Tempory Identity (RNTI).

In a Sidelink (SL) communication, a Resource Pool (RP) is a set of resources assigned to the sidelink procedure. The resource pool consists of the subframes and the resource blocks within. There are two modes of resource assignment in SL communication: In SL communication Mode 1, the eNB indicates the resources to be used for transmission, including the resources within an RP. In communication Mode 2, UE selects an RP and the resources therein from a set of assigned pools. Based on legacy resource selection mechanism in SL communication mode 2, a UE performs resource selection at a time slot. The candidate resources within resource selection window are determined based on the monitoring result within sensing window. UE will exclude the reserved resources within resource selection window for a another UE and report available resources as candidate resources to higher layers.

However, the legacy resource selection mechanism fails to consider the Listen Before Talk (LBT) mechanism for the unlicensed bands. The LBT procedure will be performed by both the resource selection UE and the resource reservation UE before their respective SL transmissions. As such, if a resource before reserved resource is selected, the transmission on the selected resource may have impact on the transmission on the reserved resource. Specifically, before a resource reservation UE performs the SL transmission on the reserved resource, a LBT procedure will be performed. For example, if the LBT type of LBT procedure for the resource reservation UE is type 1 LBT (Cat 4), the sensing interval may be large and thus the transmission on the selected resource before the reserved resource will be detected. It will cause LBT failure of the LBT procedure for the resource reservation UE. Similarly, if a resource after reserved resource is selected, the transmission on the reserved resource may have impact on the transmission on the selected resource, since a LBT procedure is also needed for the transmission on the selected resources for the resource selection UE. In this case, the transmission on the reserved resource will be detected by the LBT procedure for the resource selection UE. It will cause LBT failure of the LBT procedure for the resource selection UE.

It is therefore an object of the present application to provide methods and apparatuses for resource selection on unlicensed band with considering LBT mechanism.

### BRIEF SUMMARY

Methods and apparatuses for resource selection on unlicensed band are disclosed.

In one embodiment, a first User Equipment (UE) comprises: a transceiver; and a processor coupled to the transceiver, wherein the processor is configured to perform the operations comprising: receiving, via the transceiver, a Sidelink Control Information (SCI) indicating that a resource at a time slot is reserved for a subsequent transmission, wherein, the SCI at least comprises a Listen Before Talk (LBT) type indication that indicates a LBT operation type for the subsequent transmission on a reserved resource; and determining, based at least in part on the SCI for the subsequent transmission and/or a LBT operation type of the first UE, one or more resources to be excluded from a candidate resource set.

In one embodiment, the LBT operation type indication can comprise data representing the LBT operation type for the subsequent transmission and/or a Channel Occupancy Time (COT) indication that indicates whether a COT is initialized or not for the subsequent transmission. The LBT operation type comprises a LBT type 1 and/or a LBT type 2, and wherein the LBT type 2 comprises a LBT type 2A, a LBT type 2B, and/or a LBT type 2C. The SCI further comprises a priory indication that indicates a priory of the subsequent transmission. The priory indication comprising Channel Access Priority Class (CAPC) level of the subsequent transmission and/or a priority level of the subsequent transmission.

In some embodiment, determining the one or more resources to be excluded from the candidate resource set further comprises: determining, based at least in part on a sensing interval of the LBT operation type for the subsequent transmission, a resource before the reserved resource to be excluded from the candidate resource set.

In some embodiment, determining the one or more resources to be excluded from the candidate resource set further comprises: determining that the priority of the subsequent transmission is higher than or equal to the priority of the first UE, and/or a destination UE of the subsequent transmission is the first UE; and determining, based on processing time for decoding SCI and/or a sensing interval of LBT operation type 2, the resource before the reserved resource to be excluded from the candidate resource set.

In some embodiment, determining the one or more resources to be excluded from the candidate resource set further comprises: determining the priority of the subsequent transmission is lower than the priority of the first UE and/or a destination UE of the subsequent transmission is not the first UE; and determining, based on sensing interval of LBT operation type 1, the resource before the reserved resource to be excluded from the candidate resource set.

In one embodiment, determining the one or more resources to be excluded from the candidate resource set further comprises: determining, based at least in part on a sensing interval of LBT operation type of the first UE, a resource after the reserved resource to be excluded from the candidate resource set.

In one embodiment, determining the one or more resources to be excluded from the candidate resource set further comprises: determining, the priority of the subsequent transmission is lower than or equal to the priority of the first UE, and/or a destination UE of a transmission from the first UE is a second UE for which the subsequent transmission is reserved; and determining, based on processing time for decoding SCI and/or a sensing interval of LBT operation type 2, the resource after the reserved resource to be excluded from the candidate resource set.

In one embodiment, determining the one or more resources to be excluded from the candidate resource set further comprises: determining, the priority of the subsequent transmission is higher than the priority of the first UE, and/or a destination UE of a transmission from the first UE is not a second UE of the for which subsequent transmission is reserved; and determining, based on sensing interval of LBT operation type 1, the resource after the reserved resource to be excluded from the candidate resource set.

In one embodiment, the processor is further configured to perform the operations comprising: in response to determining one or more resources to be excluded from the candidate resource set, excluding the one or more resources from the candidate resource set to obtain available resources; and reporting the available resources to higher layers.

In another embodiment, a method of a first User Equipment (UE) comprises: receiving, a Sidelink Control Information (SCI) indicating that a resource at a time slot is reserved for a subsequent transmission, wherein, the SCI at least comprises a Listen Before Talk (LBT) type indication that indicates a LBT operation type for the subsequent transmission on a reserved resource; and determining, based at least in part on the SCI for the subsequent transmission and/or a LBT operation type of the first UE, one or more resources to be excluded from a candidate resource set

In yet another embodiment, a second User Equipment (UE) comprises: a transceiver; and a processor coupled to the transceiver, wherein the processor is configured to perform the operations comprising: transmitting, via the transceiver, a Sidelink Control Information (SCI) indicating that a resource at a time slot is reserved for a transmission from the second UE, wherein, the SCI of the second UE at least comprises a Look Before Talk (LBT) type indication to indicate a LBT operation type for the subsequent transmission of the second UE on the reserved resource; determining, based at least in part on the SCI of the second UE, one or more resources to be excluded from a candidate resource set; and transmitting, via the transceiver, an indication of one or more resources to be excluded from the candidate resource set.

In a further embodiment, a method of a second User Equipment (UE) comprises: transmitting, a Sidelink Control Information (SCI) indicating that a resource at a time slot is reserved for a transmission from the second UE, wherein, the SCI of the second UE at least comprises a Look Before Talk (LBT) type indication to indicate a LBT operation type for the subsequent transmission of the second UE on the reserved resource; determining, based at least in part on the SCI of the second UE, one or more resources to be excluded from a candidate resource set; and transmitting, an indication of one or more resources to be excluded from the candidate resource set.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates an example of a conventional resource selection method in a sidelink communication;

FIG. 2 illustrates an example of a resource selection method according to a first embodiment;

FIG. 3 illustrates another example of the resource selection method according to the first embodiment;

FIG. 4 illustrates an example of the resource selection method according to a second embodiment;

FIG. 5 illustrates another example of the resource selection method according to the second embodiment;

FIG. 6 is a schematic flow chart diagram illustrating a first embodiment of a method for resource selection;

FIG. 7 is a schematic flow chart diagram illustrating a second embodiment of a method for resource selection; and

FIG. 8 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code.

This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

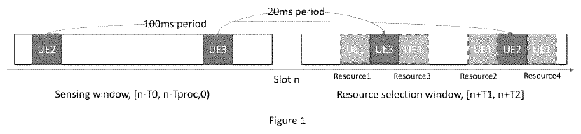

FIG. 1 illustrates an example of a conventional resource selection method in a sidelink communication.

As shown in FIG. 1, based on legacy resource selection mechanism in SL communication mode 2, a resource selection UE (UE1) performs resource selection at time slot n. The candidate resources within resource selection window [n+T1, n+T2] are determined based on the monitoring result within sensing window [n-T0, n-Tproc,0). UE1 will exclude the reserved resources of a resource reservation UE (UE2 or UE3) within resource selection window and report available resources as candidate resources to higher layers.

The resource selection procedure is recorded in TS 38.214 as shown below.

Resource selection procedure in TS 38.214:

The following steps are used:

```
1) A candidate single-slot resource for transmission R_{x,y} is defined as a set of L_{subCH} contiguous sub-channels
    $with sub - channel x + j in slot {t}_{y}^{SL} where j = 0 , ... , {L}_{subCH} - 1 . The UE shall assume that any set of {L}_{subCH}$
    contiguous sub-channels included in the corresponding resource pool within the time interval [n +T₁, n +
    T₂] correspond to one candidate single-slot resource, where
      selection of T₁ is up to UE implementation under 0 ≤ T₁ ≤T_{proc,1} , where T_{proc,1} is TBD;
      if T₂ₘᵢₙ is shorter than the remaining packet delay budget (in slots) then T₂ is up to UE implementation
      subject to T₂ₘᵢₙ ≤ T₂ ≤ remaining packet budget (in slots); otherwise T₂ is set to the remaining packet
      delay budget (in slots).
    The total number of candidate single-slot resources is denoted by Mₜₒₜₐₗ.
2) The sensing window is defined by the range of slots [n − T₀, n − T_{proc,0}) where To is defined above and T_{proc,1}
    is TBD. The UE shall monitor slots which can belong to a sidelink resource pool within the sensing window
    except for those in which its own transmissions occur. The UE shall perform the behaviour in the following
    steps based on PSCCH decoded and RSRP measured in these slots.
3) The internal parameter Th(pᵢ) is set to the corresponding value from higher layer parameter SL-
    ThresRSRP_pi_pj for pⱼ equal to the given value of prio_{TX} and each priority value pᵢ.
4) The set S_{A} is initialized to the set of all the candidate single-slot resources.
5) The UE shall exclude any candidate single-slot resource R_{x,y} from the set S_{A} if it meets all the following
    conditions:
      $the UE has not monitored slot {t}_{m}^{SL} in Step 2.$
      for any periodicity value allowed by the higher layer parameter reservationPeriodAllowed and a
      $hypothetical SCI format 0 - 1 received in slot {t}_{m}^{SL} {with }^{″} Resource reservation {period}^{″} field set to that$
      periodicity value and indicating all subchannels of the resource pool in this slot, condition c in step 6
      would be met.
6) The UE shall exclude any candidate single-slot resource R_{x,y} from the set S_{A} if it meets all the following
    conditions:
    $a ) the UE receives an SCI format 0 \text{-1} in slot {t}_{m}^{SL} , {and}^{″} Resource reservation {period}^{″} field , if present , and$
      ″Priority″ field in the received SCI format 0-1 indicate the values Pᵣₛᵥₚ_RX and prio_{RX}, respectively
      according to Clause [TBD] in [6, TS 38.213];
    b) the RSRP measurement performed, according to clause 8.4.2.1 for the received SCI format 0-1, is higher
      than Th(prio_{RX});
    $c ) the SCI format received in slot {t}_{m}^{SL} or the same SCI format which , if and only if {the}^{″} Resource reservation$
      ${period}^{″} field is present in the received SCI format 0 - 1 , is assumed to be received in slot ( s ) {t}_{m + q \times {P}_{rsvp \_ RX}^{′}}^{SL}$
      determines according to clause [TBD] in [6, TS 38.213] the set of resource blocks and slots which
      $overlaps with {R}_{x , y + j \times {P}_{rsvp \_ TX}^{′}} for q = 1 , 2 , ... , Q and j = 0 , 1 , ... , {C}_{resel} - 1. Here , {P}_{rsvp\_RX}^{′} is {P}_{rsvp\_RX}$
      $converted to units of logical slots , Q = ⌈ \frac{{T}_{scal}}{{P}_{rsvp \_ RX}} ⌉ if {P}_{rsvp\_TX} < {T}_{scal} and {n}^{′} - m \leq {P}_{rsvp\_RX}^{′} , where$
      ${t}_{{n}^{′}}^{SL} = n if slot n belongs to the set ( {t}_{0}^{SL} , {t}_{1}^{SL} , … , {t}_{{T}_{max}}^{SL} ) , otherwise slot {t}_{{n}^{′}}^{SL} is the first slot after slot n$
      $belonging to the set ( {t}_{0}^{SL} , {t}_{1}^{SL} , … , {t}_{{T}_{max}}^{SL} ) ; otherwise Q = 1. {T}_{scal} is FFS .$
7) If the number of candidate single-slot resources remaining in the set S_{A} is smaller than 0.2 ·Mₜₒₜₐₗ, then
    Th(pᵢ) is increased by 3 dB for each priority value Th(pᵢ) and the procedure continues with step 4.
```

The UE shall report set S_{A} to higher layers.

Based on the legacy resource selection procedure, the resources 1, 2, 3 and 4 can be determined as candidate resources and reported to higher layers. However, the legacy resource selection mechanism fails to consider the Listen Before Talk (LBT) mechanism for the unlicensed bands.

When a resource (e.g., resource 1, 2) before reserved resource is selected by UE1, the transmission on the selected resource may have impact on the transmission on reserved resources of UE2 and UE3. Specifically, before UE2 and UE3 perform their SL transmissions on reserved resources, a LBT procedure will be performed by UE2 and UE3. For example, if the LBT type of LBT procedure for UE2 or UE3 is type 1 LBT (Cat 4), the sensing interval may be large and the transmissions on resources 1 and 2 will be detected. It will cause LBT failure of the LBT procedure for UE2 or UE3.

Similarly, when a resource (e.g., resource 3, 4) after reserved resource is selected by UE1, the transmission on reserved resources of UE2 and UE3 may have impact on the transmissions on resources 3, 4 for UE1, since a LBT procedure is also needed for the transmissions on resources 3, 4 for UE1. In this case, the transmission on the reserved resource will be detected by the LBT procedure for UE1. It will cause LBT failure of the LBT procedure for UE1.

Therefore, the legacy resource selection mechanism needs to be enhanced with considering LBT mechanism. The legacy resource selection mechanism can be improved in the following aspects, for example: resource selection for multiple TBs or multiple transmissions of a TB in one COT; resources selection with considering other UE's COT; resource selection in a potential COT (initialized/shared by the other UE); and resource selection and initialization of a COT.

The present application provides methods and apparatuses for resource selection on unlicensed band with considering LBT mechanism.

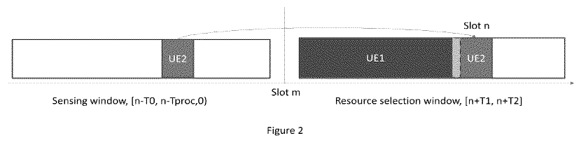

FIG. 2 illustrates an example of a resource selection method according to a first embodiment.

In the first embodiment, when a reserved resource at a time slot is detected, a resource before the reserved resource is excluded from a candidate resource set for the resource selection UE (UE1).

The resource reservation UE (UE2) transmits a Sidelink Control Information (SCI) indicating that a resource at a time slot is reserved for a subsequent transmission.

The SCI may comprise a Listen Before Talk (LBT) type indication that indicates a LBT operation type for the subsequent transmission on a reserved resource.

The LBT operation type indication comprises data representing the LBT operation type for the subsequent transmission and/or a Channel Occupancy Time (COT) indication that indicates whether a COT is initialized or not for the subsequent transmission.

The LBT operation type comprises a LBT type 1 and/or a LBT type 2, and wherein the LBT type 2 comprises a LBT type 2A, a LBT type 2B, and/or a LBT type 2C.

The SCI further comprises a priory indication that indicates a priory for the subsequent transmission.

The priory indication comprises Channel Access Priority Class (CAPC) level for the subsequent transmission and/or a priority level for the subsequent transmission.

The Type 1 channel access procedure for UL is recorded in TS37.213 as shown below.

Type 1 channel access procedure for UL in TS37.213

This subclause describes channel access procedures by a UE where the time duration spanned by
the sensing slots that are sensed to be idle before a UL transmission(s) is random. The subclause
is applicable to the following transmissions:

| | |
|---|---|
| - | PUSCH/SRS transmission(s) scheduled or configured by eNB/gNB, or |
| - | PUCCH transmission(s) scheduled or configured by gNB, or |
| - | Transmission(s) related to random access procedure. |

A UE may transmit the transmission using Type 1 channel access procedure after first sensing
the channel to be idle during the slot durations of a defer duration T_{d}, and after the counter N is
zero in step 4. The counter N is adjusted by sensing the channel for additional slot duration(s)
according to the steps described below.

| | |
|---|---|
| 1) | set N = Nᵢₙᵢₜ, where Nᵢₙᵢₜ is a random number uniformly distributed between 0 and CWₚ, |
| | and go to step 4; |
| 2) | if N > 0 and the UE chooses to decrement the counter, set N = N − 1; |
| 3) | sense the channel for an additional slot duration, and if the additional slot duration is |
| | idle, go to step 4; else, go to step 5; |
| 4) | if N = 0, stop; else, go to step 2. |
| 5) | sense the channel until either a busy slot is detected within an additional defer duration T_{d} |
| | or all the slots of the additional defer duration T_{d} are detected to be idle; |
| 6) | if the channel is sensed to be idle during all the slot durations of the additional defer |
| | duration T_{d}, go to step 4; else, go to step 5; |

If a UE has not transmitted a UL transmission on a channel on which UL transmission(s) are
performed after step 4 in the procedure above, the UE may transmit a transmission on the
channel, if the channel is sensed to be idle at least in a sensing slot duration Tₛₗ when the UE is
ready to transmit the transmission and if the channel has been sensed to be idle during all the slot
durations of a defer duration T_{d} immediately before the transmission. If the channel has not been
sensed to be idle in a sensing slot duration Tₛₗ when the UE first senses the channel after it is
ready to transmit, or if the channel has not been sensed to be idle during any of the sensing slot
durations of a defer duration T_{d} immediately before the intended transmission, the UE proceeds
to step 1 after sensing the channel to be idle during the slot durations of a defer duration T_{d}.
The defer duration T_{d} consists of duration T_{f} = 16us immediately followed by mₚ consecutive
slot durations where each slot duration is Tₛₗ = 9us, and T_{f} includes an idle slot duration Tₛₗ at
start of T_{f}.
CW_{min,p} ≤ CWₚ ≤ CW_{max,p} is the contention window. CWₚ adjustment is described in
subclause 4.2.2.
CW_{min,p} and CW_{max,p} are chosen before step 1 of the procedure above.
mₚ, CW_{min,p}, and CW_{max,p} are based on a channel access priority class p as shown in Table
4.2.1-1, that is signalled to the UE.

TABLE 4.2.1-1
Channel Access Priority Class for UL

| Channel Access | | | | | |
|---|---|---|---|---|---|
| Priority Class (p) | mₚ | CW_{min, p} | CW_{max, p} | T_{ulm cot, p} | allowed CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or 10 ms | {15, 31, 63, 127, |
| | | | | | 255, 511, 1023} |
| 4 | 7 | 15 | 1023 | 6 ms or 10 ms | {15, 31, 63, 127, |
| | | | | | 255, 511, 1023} |

NOTE1:
For p = 3, 4, T_{ulm cot, p} = 10 ms if the higher layer parameter ‘absenceOfAnyOtherTechnology-r14’ indicates TRUE, otherwise, T_{ulm cot, p} = 6 ms.
NOTE 2:
When T_{ulm cot, p} = 6 ms it may be increased to 8 ms by inserting one or more gaps. The minimum duration of a gap shall be 100 μs. The maximum duration before including any such gap shall be 6 ms.

The Priority Level is recorded in TS 23.387 as shown below.

5.4.3.3 Priority Level, TS 23.387

The Priority Level for NR PC5 has the same format and meaning as the Priority value of the
ProSe Per-Packet Priority (PPPP) for LTE PC5 defined in TS 23.285 [8]. For LTE PC5, the
PPPP value also reflects the latency requirement and the PDB derivation is according to
TS 23.285 [8], i.e. the low PDB is mapped to the high priority PPPP value. On the other hand,
for NR PC5, the PDB is derived from the PQI table as defined in clause 5.4.4.
NOTE: Using the same format for Priority Level and PPPP provides better backward compatibility.
The Priority Level shall be used to different treatment of V2X service data across different
modes of communication, i.e. broadcast, groupcast, and unicast. In the case when all QoS
requirements cannot be fulfilled for all the PC5 service data associated with that PC5 reference
point, the Priority Level shall be used to select for which PC5 service data the QoS requirements
are prioritized such that a PC5 service data packet with Priority Level value N is prioritized over
a PC5 service data packet with higher Priority Level values, i.e. N+1, N+2, etc

The relationship of the Priority Level and the CAPC is shown in table 1.

TABLE 1

| Priority Level | CAPC |
|---|---|
| 0 | 1 |
| 1 | 1 |
| 2 | 2 |
| 3 | 2 |
| 4 | 3 |
| 5 | 3 |
| 6 | 4 |
| 7 | 4 |

The priority level and the CAPC level can represent a priority of a transmission. A lower priority level or a lower CAPC level can indicate a higher priority of a transmission, or a larger size of a contention window/sensing interval of LBT operation.

SCI can include a field of 1bit, representing that a LBT procedure of LBT type 1, or LBT type 2 will be performed by UE2 for the transmission on reserved resource.

SCI can include a field of 2bits, representing that a LBT procedure of LBT type 1, or LBT type 2A, or type 2B, or 2C will be performed by UE2 for the transmission on reserved resource.

SCI can include a field of 1bit, representing that whether a COT is initialized or not for the subsequent transmission of UE2. If a COT is initialized for the subsequent transmission of UE2, UE2 can use the initialized COT for the subsequent transmission on the reserved resource. If a COT is not initialized for the subsequent transmission of UE2, UE2 will use a shared COT initialized by other UE for the transmission on the reserved resource.

For the resource selection UE1, it can determine, based on legacy selection procedure in TS 38.214 as shown above, the excluded resource from a candidate resource set including one or more resources to be selected by UE1. In addition, the resource selection UE1 further takes the LBT procedure into account when it performs the resource selection procedure. In the first embodiment, UE1 determines one or more resources to be excluded from the candidate resource set based on the LBT procedure of UE2.

UE1 receives the SCI indicating that a resource at a time slot is reserved for a subsequent transmission from UE2. UE1 can determine, based on the received SCI of UE2, a resource before the reserved resource to be excluded from a candidate resource set.

For example, when a reserved resource at time slot n is detected, a resource before time slot n-k can be selected by UE1 and the resources from the time slot n-k to slot n will be excluded by UE1. The time slot k can be determined based on the following method as presented below.

According to example embodiment as shown in FIG. 2, if the SCI of UE2 indicates that the type 2 LBT procedure is to be performed by UE2, the resource to be excluded from the candidate resource set can be determined based on a sensing interval of LBT type 2. As shown in FIG. 2, the length of the region in time domain indicating the resource to be excluded from the candidate resource set can be determined based on a sensing interval of LBT type 2, e.g., 1 or 2 symbols. Further, in order to ensure that UE2 can decode a SCI for LBT type indication, the resource to be excluded from the candidate resource set can be determined based on processing time for UE2 to decode the SCI and determine the LBT type. The length of the region in time domain can further be determined based on the processing time of decoding SCI. The length of the region in time domain can also be (pre) configured (per resource pool) by a gNB. Therefore, if the SCI of UE2 indicates that the type 2 LBT procedure is to be performed by UE2, the resource to be excluded from the candidate resource set can be determined based on a sensing interval of LBT type 2 and/or the processing time of decoding SCI.

In one aspect, if the SCI of UE2 indicates that a COT is not initialized by UE2 for its subsequent transmission on the reserved resource, it means that UE2 will use a shared COT initialized by other UE. In this case, it can be determined that the type 2 LBT procedure is to be performed by UE2 for subsequent transmission on the reserved resource. Thus, the resource to be excluded from the candidate resource set can be determined based on a sensing interval of LBT type 2. Further, in order to ensure that UE2 can decode a SCI for a COT indication (initialized/shared), the resource to be excluded from the candidate resource set can further be determined based on processing time for decoding the SCI to determine the COT indication.

If the SCI of UE2 indicates that the priority of UE2's transmission is higher than or equal to the priority of the transmission from UE1, it means that the COT of UEL can be shared with UE2. In this case, it can be determined that the type 2 LBT procedure will be performed by UE2 for the subsequent transmission on the reserved resource. Thus, the resource to be excluded from the candidate resource set can be determined based on a sensing interval of LBT type 2 and/or the processing time of decoding SCI. The priority of UE2's transmission can be determined based on the Channel Access Priority Class (CAPC) level for the subsequent transmission of UE2 and/or a priority level for the subsequent transmission of UE2. A lower priority level or a lower CAPC level of the subsequent transmission of UE2 can represent a higher priority of the transmission, or a larger size of a contention window/sensing interval of LBT operation.

If the destination UE of the transmission from UE2 is UE1, it means that the COT of UE1 can be shared with UE2. In this case, it can be determined that the type 2 LBT procedure is to be performed by UE2 for subsequent transmission on the reserved resource. Thus, the resource to be excluded from the candidate resource set can be determined based on a sensing interval of LBT type 2 and/or the processing time of decoding SCI.

After one or more resources to be excluded from the candidate resource set are determined, UE1 can exclude the one or more resources from the candidate resource set to obtain available resources and report the available resources to higher layers.

In another aspect, when the resource selection UE1 receives an indication of the selected resource from higher layers, UE1 can perform a LBT procedure on the selected resource. For example, when UE1 performs a LBT procedure of the LBT type 1 and initializes a COT, whether the COT of the resource selection UE1 can be shared with the resource reservation UE2 can be determined based at least in part on: whether the priority of the transmission from the resource reservation UE2 is higher than or equal to the priority of the transmission from UE1 and/or whether a destination UE of the transmission from UE2 is UE1. If the priority for the transmission from UE2 is higher than or equal to the priority of the transmission from UE1 and/or if a destination UE of the transmission from UE2 is UE1: the COT of the resource selection UE1 can be shared with UE2. On the contrary, if the priority for the transmission from UE2 is lower than the priority of the transmission from UE1 and/or the destination UE of the transmission from UE2 is not UE1: the COT of UE1 cannot be shared with UE2. If the COT of UE1 can be shared with UE2, it means that the type 2 LBT procedure is to be performed by UE2. On the contrary, if the COT of UE1 cannot be shared with UE2, it means that the type 1 LBT procedure is to be performed by UE2.

In another aspect, the one or more resources to be excluded from a candidate resource set can be determined by the resource reservation UE2, and an indication of the one or more resources to be excluded from a candidate resource set can be transmitted from the resource reservation UE2 to the resource selection UE1.

UE2 can transmit, a Sidelink Control Information (SCI) indicating that a resource at a time slot is reserved for a transmission from UE2. UE2 can determine, based at least in part on the SCI of UE2, one or more resources to be excluded from a candidate resource set. UE2 can transmit an indication of one or more resources to be excluded from the candidate resource set.

For example, UE2 can transmit an indication to indicate a timing offset k representing that, for the transmission at time slot n, the time duration [n-k, n] is not available. In other words, UE2 have reserved the resource from the time slot n-k to slot n.

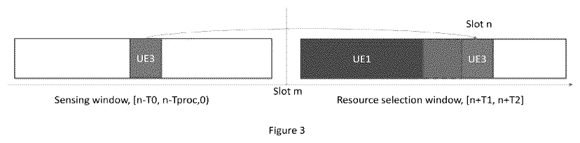

FIG. 3 illustrates another example of the resource selection method according to the first embodiment.

According to example embodiment as shown in FIG. 3, if the SCI of UE3indicates that the type 1 LBT procedure is to be performed by UE3, the resource to be excluded from the candidate resource set can be determined based on a sensing interval of LBT type 1. As shown in FIG. 3, the length of the region in time domain indicating the resource to be excluded from the candidate resource set can be determined based on a sensing interval of LBT type 1.

In one aspect, if the SCI of UE3 indicates that a COT is initialized by UE3 for its subsequent transmission on the reserved resource, it can be determined that the type 1 LBT procedure is to be performed by UE3 for subsequent transmission on the reserved resource. Thus, the resource to be excluded from the candidate resource set can be determined based on a sensing interval of LBT type 1.

If the SCI of UE3 indicates that the priority of UE3's transmission is lower than the priority of the transmission from UE1, it means that the COT of the resource selection UE1 cannot be shared with UE3. In this case, it can be determined that the type 1 LBT procedure is to be performed by UE3 for subsequent transmission on the reserved resource. Thus, the resource to be excluded from the candidate resource set can be determined based on a sensing interval of LBT type 1. The priority of UE3's transmission can be determined based on the Channel Access Priority Class (CAPC) level for the subsequent transmission of UE3 and/or a priority level for the subsequent transmission of UE3.

If the destination UE of the transmission from UE3 is not the resource selection UE1, it means that the COT of UEL cannot be shared with UE3. In this case, it can be determined that the type 1 LBT procedure is to be performed by UE3 for subsequent transmission on the reserved resource. Thus, the resource to be excluded from the candidate resource set can be determined based on a sensing interval of LBT type 1.

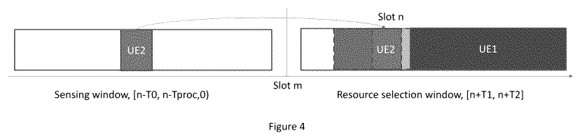

FIG. 4 illustrates an example of the resource selection method according to a second embodiment.

In the second embodiment, when a reserved resource at a time slot is detected, a resource after the reserved resource is excluded from a candidate resource set for the resource selection UE1.

As is similar to the first embodiment, the resource reservation UE2 transmits a Sidelink Control Information (SCI) indicating that a resource at a time slot is reserved for a subsequent transmission.

For the resource selection UE1, it can determine, based on legacy selection procedure in TS 38.214 as shown above, the excluded resource from a candidate resource set including one or more resources to be selected by UE1. In addition, UE1 further takes the LBT procedure into account when it performs the resource selection procedure. In the second embodiment, the resource selection UE1 determines one or more resources to be excluded from the candidate resource set based on the LBT procedure of UE1.

The resource selection UE1 receives the SCI indicating that a resource at a time slot is reserved for a subsequent transmission from UE2. UE1 can determine, based on the received SCI of UE2, a resource after the reserved resource to be excluded from a candidate resource set.

According to example embodiment as shown in FIG. 4, if the type 2 LBT procedure is to be performed by UE1, the resource to be excluded from the candidate resource set can be determined based on a sensing interval of LBT type 2. As shown in FIG. 4, the length of the region in time domain indicating the resource to be excluded from the candidate resource set can be determined based on a sensing interval of LBT type 2, e.g., 1 or 2 symbols. Further, in order to ensure that UE1 can decode a SCI for LBT type indication, the resource to be excluded from the candidate resource set can be determined based on processing time for UE1 to decode the SCI and determine the LBT type. The length of the region in time domain can further be determined based on the processing time of decoding SCI. The length of the region in time domain can also be (pre) configured (per resource pool) by gNB. Therefore, if UE1 is determined to perform a LBT procedure of LBT type 2, the resource to be excluded from the candidate resource set can be determined based on a sensing interval of LBT type 2 and/or the processing time of decoding SCI.

In one aspect, the SCI of UE2 indicates that the type 1 LBT procedure is to be performed by UE2 or a COT is initialized by UE2 for its subsequent transmission on the reserved resource. If the SCI of UE2 indicates that the priority of UE2's transmission is lower than the priority of the transmission from resource selection UE1 and/or the destination UE of the transmission from resource selection UE1 is UE2, it means that the COT initialized by the resource reservation UE2 can be shared with UE1. In this case, it can be determined that a type 2 LBT procedure will be performed by UE1 for the transmission on the selected resource. Thus, the resource to be excluded from the candidate resource set can be determined based on a sensing interval of LBT type 2 and/or the processing time of decoding SCI.

After one or more resources to be excluded from the candidate resource set are determined, UE1 can exclude the one or more resources from the candidate resource set to obtain available resources and report the available resources to higher layers.

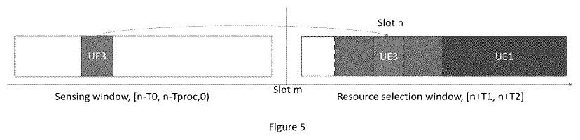

FIG. 5 illustrates another example of the resource selection method according to the second embodiment.

According to example embodiment as shown in FIG. 5, if the type 1 LBT procedure is to be performed by UE1, the resource to be excluded from the candidate resource set can be determined based on a sensing interval of LBT type 1. As shown in FIG. 5, the length of the region in time domain indicating the resource to be excluded from the candidate resource set can be determined based on a sensing interval of LBT type 1 of UE1.

In one aspect, the SCI of UE3 indicates that the type 1 LBT procedure is to be performed by UE3 or a COT is initialized by UE3 for its subsequent transmission on the reserved resource. If the SCI of UE3 indicates that the priority of UE3's transmission is higher than the priority of the transmission from resource selection UE1 or the destination UE of the transmission from resource selection UE1 is not UE3, it means that the COT of the resource reservation UE3 cannot be shared with UE1. In this case, it can be determined that a type 1 LBT procedure is to be performed by UE1 for the transmission on the selected resource. Thus, the resource to be excluded from the candidate resource set can be determined based on a sensing interval of LBT type 1.

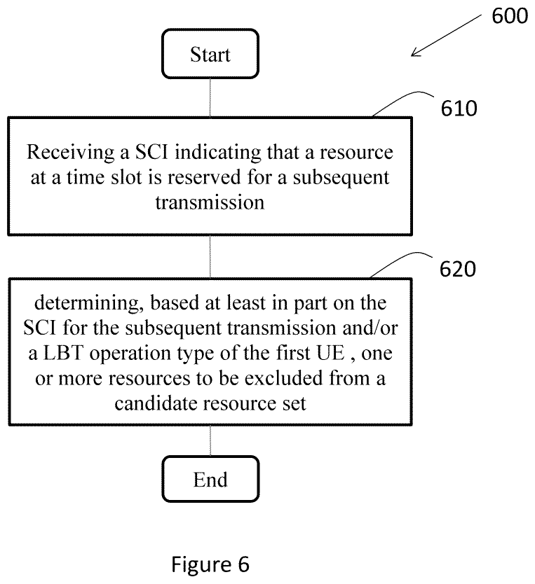

FIG. 6 is a schematic flow chart diagram illustrating a first embodiment of a method 600 for resource selection. In some embodiments, the method 600 is performed by an apparatus, such as a resource selection UE1. In certain embodiments, the method 600 may be performed by a processor executing program code, for example, a microcontroller, a microprocessor, a CPU, a GPU, an auxiliary processing unit, a FPGA, or the like.

The method 600 may include 610 receiving, a Sidelink Control Information (SCI) indicating that a resource at a time slot is reserved for a subsequent transmission. the SCI at least comprises a Listen Before Talk (LBT) type indication that indicates a LBT operation type for the subsequent transmission on a reserved resource; and 620 determining, based at least in part on the SCI for the subsequent transmission and/or a LBT operation type of the first UE, one or more resources to be excluded from a candidate resource set.

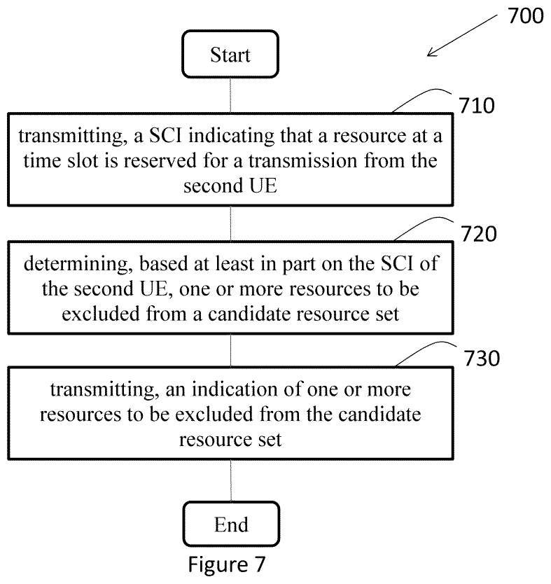

FIG. 7 is a schematic flow chart diagram illustrating a second embodiment of a method 700 for sidelink resource selection. In some embodiments, the method 700 is performed by an apparatus, such as a resource reservation UE. In certain embodiments, the method 700 may be performed by a processor executing program code, for example, a microcontroller, a microprocessor, a CPU, a GPU, an auxiliary processing unit, a FPGA, or the like.

The method 700 may include 710 transmitting, a Sidelink Control Information (SCI) indicating that a resource at a time slot is reserved for a transmission from the second UE. The SCI of the second UE at least comprises a Look Before Talk (LBT) type indication to indicate a LBT operation type for the subsequent transmission of the second UE on the reserved resource; 720 determining, based at least in part on the SCI of the second UE, one or more resources to be excluded from a candidate resource set; and 730 transmitting an indication of one or more resources to be excluded from the candidate resource set.

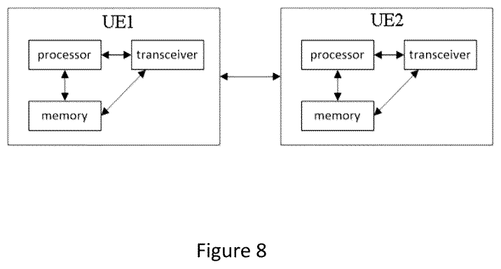

FIG. 8 is a schematic block diagram illustrating apparatuses according to one embodiment.

Referring to FIG. 8, UE1 (i.e. the resource selection UE) includes a processor, a memory, and a transceiver. The processor implements a function, a process, and/or a method which are proposed in FIGS. 6 and 7. UE 2 (i.e. the resource reservation UE) includes a processor, a memory, and a transceiver. The processors implement a function, a process, and/or a method which are proposed in FIG. 5. Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A first user equipment (UE) for wireless communication, comprising:
at least one memory; and
at least one processor coupled with the at least one memory and configured to cause the first UE to:
receive a sidelink control information (SCI) indicating that a resource at a time slot is reserved for a subsequent transmission, wherein the SCI comprises a listen before talk (LBT) type indication that indicates a LBT operation type for the subsequent transmission on a reserved resource; and
determine, based at least in part on the SCI for the subsequent transmission and/or a LBT operation type of the first UE, one or more resources to be excluded from a candidate resource set.

2. The first UE of claim 1, wherein the LBT operation type indication comprises data representing the LBT operation type for the subsequent transmission and/or a channel occupancy time (COT) indication that indicates whether a COT is initialized or not for the subsequent transmission.

3. The first UE of claim 2, wherein the LBT operation type comprises a LBT type 1 and/or a LBT type 2, and wherein the LBT type 2 comprises a LBT type 2A, a LBT type 2B, and/or a LBT type 2C.

4. The first UE of claim 3, wherein the SCI further comprises a priority indication that indicates a priority of the subsequent transmission.

5. The first UE of claim 4, wherein a priority indication comprises a channel access priority class (CAPC) level of the subsequent transmission and/or a priority level of the subsequent transmission.

6. The first UE of claim 5, wherein to determine the one or more resources to be excluded from the candidate resource set, the at least one processor is further configured to cause the first UE to:
determine, based at least in part on a sensing interval of the LBT operation type for the subsequent transmission, a resource before the reserved resource to be excluded from the candidate resource set.

7. The first UE of claim 6, wherein to determine the one or more resources to be excluded from the candidate resource set, the at least one processor is further configured to cause the first UE to:
determine that the priority of the subsequent transmission is higher than or equal to a priority of the first UE, and/or a destination UE of the subsequent transmission is the first UE; and
determine, based on processing time for decoding SCI and/or a sensing interval of LBT operation type 2, the resource before the reserved resource to be excluded from the candidate resource set.

8. The first UE of claim 6, wherein to determine the one or more resources to be excluded from the candidate resource set, the at least one processor is further configured to cause the first UE to:
determine the priority of the subsequent transmission is lower than a priority of the first UE and/or a destination UE of the subsequent transmission is not the first UE; and
determine, based on sensing interval of LBT operation type 1, the resource before the reserved resource to be excluded from the candidate resource set.

9. The first UE of claim 5, wherein to determine the one or more resources to be excluded from the candidate resource set, the at least one processor is further comprising configured to cause the first UE to:
determine, based at least in part on a sensing interval of LBT operation type of the first UE, a resource after the reserved resource to be excluded from the candidate resource set.

10. The first UE of claim 9, wherein to determine the one or more resources to be excluded from the candidate resource set, the at least one processor is further configured to cause the first UE to:
determine, the priority of the subsequent transmission is lower than or equal to a priority of the first UE, and/or a destination UE of a transmission from the first UE is a second UE for which the subsequent transmission is reserved; and
determine, based on processing time for decoding SCI and/or a sensing interval of LBT operation type 2, the resource after the reserved resource to be excluded from the candidate resource set.

11. The first UE of claim 9, wherein to determine the one or more resources to be excluded from the candidate resource set, the at least one processor is further configured to cause the first UE to:
determine, the priority of the subsequent transmission is higher than the priority of the first UE, and/or a destination UE of a transmission from the first UE is not a second UE of the for which subsequent transmission is reserved; and
determine, based on sensing interval of LBT operation type 1, the resource after the reserved resource to be excluded from the candidate resource set.

12. The first UE of claim 1, wherein the at least one processor is further configured to cause the first UE to:
in response to determining one or more resources to be excluded from the candidate resource set, exclude the one or more resources from the candidate resource set to obtain available resources, and
report the available resources to higher layers.

13. A method performed by a first user equipment (UE), comprising:
receiving, a sidelink control information (SCI) indicating that a resource at a time slot is reserved for a subsequent transmission, wherein the SCI comprises a listen before talk (LBT) type indication that indicates a LBT operation type for the subsequent transmission on a reserved resource; and
determining, based at least in part on the SCI for the subsequent transmission and/or a LBT operation type of the first UE, one or more resources to be excluded from a candidate resource set.

14. A second user equipment (UE), comprising:
at least one memory; and
at least one processor coupled with the at least one memory and configured to cause the second UE to:
transmit a sidelink control information (SCI) indicating that a resource at a time slot is reserved for a transmission from the second UE, wherein the SCI of the second UE comprises a listen before talk (LBT) type indication to indicate a LBT operation type for subsequent transmission of the second UE on the reserved resource;
determine, based at least in part on the SCI of the second UE, one or more resources to be excluded from a candidate resource set; and
transmit an indication of the one or more resources to be excluded from the candidate resource set.

15. (canceled)

16. A processor for wireless communication, comprising:
at least one controller coupled with at least one memory and configured to cause the processor to:
receive a sidelink control information (SCI) indicating that a resource at a time slot is reserved for a subsequent transmission, wherein the SCI comprises a listen before talk (LBT) type indication that indicates a LBT operation type for the subsequent transmission on a reserved resource; and
determine, based at least in part on the SCI for the subsequent transmission and/or a LBT operation type of the processor, one or more resources to be excluded from a candidate resource set.

17. The processor of claim 16, wherein the LBT operation type indication comprises data representing the LBT operation type for the subsequent transmission and/or a channel occupancy time (COT) indication that indicates whether a COT is initialized or not for the subsequent transmission.

18. The processor of claim 17, wherein the LBT operation type comprises a LBT type 1 and/or a LBT type 2, and wherein the LBT type 2 comprises a LBT type 2A, a LBT type 2B, and/or a LBT type 2C.

19. The processor of claim 18, wherein the SCI further comprises a priority indication that indicates a priority of the subsequent transmission.

20. The processor of claim 19, wherein a priority indication comprises a channel access priority class (CAPC) level of the subsequent transmission and/or a priority level of the subsequent transmission.

21. The processor of claim 20, wherein to determine the one or more resources to be excluded from the candidate resource set, the at least one controller is further configured to cause the processor to:
determine, based at least in part on a sensing interval of the LBT operation type for the subsequent transmission, a resource before the reserved resource to be excluded from the candidate resource set.
